(19) United States
(12) Patent Application Publication
(10) Pub. No.: US 2020/0052344 A1
(43) Pub. Date: Feb. 13, 2020

(54) WATER-BASED ELECTROLYTIC SOLUTION FOR LITHIUM/NATRIUM ION BATTERY AND LITHIUM/NATRIUM ION BATTERY CONTAINING THE SAME

(71) Applicants: TOYOTA JIDOSHA KABUSHIKI KAISHA, Toyota-shi (JP); SHANGHAI JIAO TONG UNIVERSITY, Shanghai (CN)

(72) Inventors: Jun YANG, Shanghai (CN); Jinhui ZHU, Shanghai (CN); Tao ZHANG, Shanghai (CN)

(73) Assignees: TOYOTA JIDOSHA KABUSHIKI KAISHA, Toyota-shi (JP); SHANGHAI JIAO TONG UNIVERSITY, Shanghai (CN)

(21) Appl. No.: 16/531,182

(22) Filed: Aug. 5, 2019

(30) Foreign Application Priority Data
Aug. 13, 2018 (CN) 201810916548.9

(51) Int. Cl. H01M 10/36

(52) U.S. Cl. CPC H01M 10/36; H01M 2300/0005

(57) ABSTRACT

The present disclosure relates to a water-based electrolytic solution for lithium/sodium ion batteries and a lithium/sodium ion battery containing the electrolytic solution. The water-based electrolytic solution for lithium/sodium ion batteries comprises a hydrophilic oxide nanoparticle uniformly dispersed in an aqueous solution of a lithium/sodium ion salt. With the water-based electrolytic solution for lithium/sodium ion batteries of the present disclosure, the potential window of the water-based electrolytic solution can be improved and hydrogen-generating side reaction can also be prevented. Accordingly, more low-voltage negative electrodes can be applied to a battery system using the water-based electrolytic solution, and the energy density of the battery can be improved.

### BACKGROUND

### 1. Field

The present disclosure relates to a water-based electrolytic solution for lithium/sodium ion batteries and a lithium/sodium ion battery containing the electrolytic solution.

### 2. Description of Related Art

High-energy density rechargeable batteries are currently key factors for the future development of the energy industry in response to rapidly growing needs for energy. Also, lithium/sodium ion batteries are research hotspots owing to their distinctive performance benefits. However, electrolytic solutions used in conventional lithium/sodium ion batteries are organic electrolytic solutions and therefore have a low conductivity and the risk of causing accidents by combustion. Hence, use of water-based electrolytic solutions has been considered instead of the organic electrolytic solutions. The water-based electrolytic solutions have advantages such as low cost, high safety, and eco-friendliness. In addition, the water-based electrolytic solutions have a higher conductivity and can also improve electric output characteristics. Meanwhile, a problem of the water-based electrolytic solutions is a narrow potential window. Since the potential window of water is stable and narrow, hydrogen-generating reaction occurs easily at a negative electrode while oxygen-generating reaction occurs easily at a positive electrode. At the present time, a method for widening the potential windows of the water-based electrolytic solutions generally involves forming a configuration of “wrapping water with a salt” using an aqueous solution of a lithium/sodium salt having a high concentration, thereby suppressing water decomposition and widening the potential window of the electrolytic solution. However, such a method requires high cost and elevates the viscosity of electrolytic solutions. Therefore, a salt deposition phenomenon might occur. Thus, it has been important to examine a simple and easy-to-work method for widening the potential window of a water-based electrolytic solution at low cost.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides a water-based electrolytic solution for lithium/sodium ion batteries which can widen a potential window, and a lithium/sodium ion battery containing the electrolytic solution. Water-based electrolytic solutions have advantages such as high conductivity and safety, and eco-friendliness. However, the water-based electrolytic solutions bring about low energy density of lithium/sodium ion batteries due to their narrow potential windows. In the present disclosure, the potential window of the water-based electrolytic solution can be drastically widened by using an inexpensive oxide nanoparticle as an additive for the water-based electrolytic solution. Furthermore, this method is simple and easy to work and also requires low cost. Therefore, the method is very advantageous in achieving industrial production.

The present disclosure is achieved by the following technical ideas.

To achieve the foregoing objectives, a water-based electrolytic solution for lithium/sodium ion batteries includes a hydrophilic oxide nanoparticle uniformly dispersed in an aqueous solution of a lithium/sodium ion salt.

In the above-described water-based electrolytic solution for lithium/sodium ion batteries, the lithium ion salt is preferably one or more of LiClO₄, LiTFSI, LiFSI, Li₂SO₄, and LiNO₃.

In the above-described water-based electrolytic solution for lithium/sodium ion batteries, the concentration of the lithium ion salt is 1 preferably to 5 mol/L.

The concentration higher than 5 mol/L is not preferred because the conductivity exceeds the measuring range of a meter and the cost is also increased. The concentration lower than 1 mol/L is not preferred because the conductivity is low.

In the above-described water-based electrolytic solution for lithium/sodium ion batteries, the hydrophilic oxide nanoparticle is preferably one or more of SiO₂, Al₂O₃, TiO₂, and ZrO₂.

In the above-described water-based electrolytic solution for lithium/sodium ion batteries, the particle size of the hydrophilic oxide nanoparticle is preferably 7 to 40 nm.

The particle size larger than 40 nm is not preferred because the oxide particle is easily precipitated in the electrolytic solution. The particle size smaller than 7 nm is not preferred because such a particle is expensive.

In the above-described water-based electrolytic solution for lithium/sodium ion batteries, the content of the hydrophilic oxide nanoparticle is preferably larger than 0 and smaller than 10 wt % and is 1 to 3 wt %.

The content of more than 3 wt % is not preferred because the viscosity is elevated and the fluidity is worsened. The content of less than 1 wt % is not preferred because the effect is not marked.

In the above-described water-based electrolytic solution for lithium/sodium ion batteries, the sodium ion salt is preferably one or more of NaClO₄, NaTFSI, NaFSI, Na₂SO₄, and NaNO₃.

In the above-described water-based electrolytic solution for lithium/sodium ion batteries, the concentration of the sodium ion salt is preferably 1 to 5 mol/L.

The concentration higher than 5 mol/L is not preferred because the conductivity exceeds the measuring range of a meter and the cost is also increased. The concentration lower than 1 mol/L is not preferred because the conductivity is low.

To achieve the foregoing objective, a lithium/sodium ion battery preferably includes the above-described water-based electrolytic solution for lithium/sodium ion batteries.

The present disclosure is advantageous over the prior art in the following items.

1. The involvement of an inexpensive oxide nanoparticle as an additive eliminates the need of using an aqueous solution of a lithium/sodium ion salt having a high concentration as a water-based electrolytic solution and can also widen a potential window.

2. Such a simple and easy-to-work method facilitates achieving industrial production.

Other features and aspects will be apparent from the following detailed description, the drawings, and the claims.

### BRIEF DESCRIPTION OF THE DRAWINGS

FIG. 1 shows a cycle voltage-current graph relating to water-based electrolytic solutions prepared in Examples 7 to 9 of the present disclosure, and a partially enlarged view thereof.

FIG. 2 shows a cycle voltage-current graph relating to water-based electrolytic solutions prepared in Examples 16 to 18 of the present disclosure, and a partially enlarged view thereof.

FIG. 3 shows a cycle voltage-current graph relating to water-based electrolytic solutions prepared in Examples 25 to 27 of the present disclosure, and a partially enlarged view thereof.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### EXAMPLES 1 TO 9

LiClO₄ was used as a lithium ion salt to prepare aqueous solutions of the lithium ion salt having respective concentrations of 1 3, and 5 M (mol/L). Then, SiO₂ having a size of 12 nm was added as an additive to the obtained aqueous solutions of the lithium ion salt such that the content was 1, 3, and 5 wt %. The particle was uniformly dispersed in the aqueous solutions of the lithium ion salt either by stirring or ultrasonically to prepare water-based electrolytic solutions for lithium ion batteries of Examples 1 to 9. The water-based electrolytic solutions for lithium ion batteries of Examples 7 to 9 were subjected to a cycle voltage-current test with stainless steel as a working electrode and Ag/AgCl as a reference electrode.

The pH values and conductivities of the water-based electrolytic solutions for lithium ion batteries prepared in Examples 1 to 9 are shown in Table 1 below.

TABLE 1

| | LiClO₄ | | | |
|---|---|---|---|---|
| | concentration | SiO₂ content | pH | Conductivity |
| | (M) | (wt %) | value | (mS/cm) |
| Example 1 | 1 | 1 | 4.86 | 57.9 |
| Example 2 | 1 | 3 | 4.87 | 54.7 |
| Example 3 | 1 | 5 | 4.46 | 54.8 |
| Example 4 | 3 | 1 | 4.52 | 116.9 |
| Example 5 | 3 | 3 | 3.78 | 116.0 |
| Example 6 | 3 | 5 | 3.76 | 115.4 |
| Example 7 | 5 | 1 | 4.43 | Larger than 200 |
| Example 8 | 5 | 3 | 4.86 | Larger than 200 |
| Example 9 | 5 | 5 | 3.76 | Larger than 200 |

The cycle voltage-current graph of the water-based electrolytic solutions for lithium ion batteries prepared in Examples 7 to 9 is shown in FIG. 1. As is evident from FIG. 1, it was observed that the reduction potential of a negative electrode was obviously negatively shifted as a result of adding SiO₂ as an additive to the water-based electrolytic solution, as compared with the case of adding no additive. Specific numerical values are shown in Table 2 below.

TABLE 2

| | | Negative shift value of negative |
|---|---|---|
| | SiO₂ content | electrode reduction potential |
| Example 7 | 1 wt % | 190 mV |
| Example 8 | 3 wt % | 160 mV |
| Example 9 | 5 wt % | 190 mV |

### EXAMPLES 10 TO 18

NaClO₄ was used as a sodium ion salt to prepare aqueous solutions of the sodium ion salt having respective concentrations of 1 3, and 5 M (mol/L). Then, SiO₂ having a size of 12 nm was added as an additive to the obtained aqueous solutions of the sodium ion salt such that the content was 1, 3, and 5 wt %. The particle was uniformly dispersed in the aqueous solutions of the sodium ion salt either by stirring or ultrasonically to prepare water-based electrolytic solutions for sodium ion batteries of Examples 1 to 9. The water-based electrolytic solutions for sodium ion batteries of Examples 16 to 18 were subjected to a cycle voltage-current test with stainless steel as a working electrode and Ag/AgCl as a reference electrode.

The pH values and conductivities of the water-based electrolytic solutions for sodium ion batteries prepared in Examples 16 to 18 are shown in Table 3 below.

TABLE 3

| | NaClO₄ | | | |
|---|---|---|---|---|
| | concentration | SiO₂ content | pH | Conductivity |
| | (M) | (wt %) | value | (mS/cm) |
| Example 10 | 1 | 1 | 5.34 | 58.2 |
| Example 11 | 1 | 3 | 4.84 | 56.4 |
| Example 12 | 1 | 5 | 5.37 | 53.0 |
| Example 13 | 3 | 1 | 4.80 | 118.5 |
| Example 14 | 3 | 3 | 5.40 | 120.6 |
| Example 15 | 3 | 5 | 4.25 | 118.2 |
| Example 16 | 5 | 1 | 4.95 | Larger than 200 |
| Example 17 | 5 | 3 | 4.83 | Larger than 200 |
| Example 18 | 5 | 5 | 4.10 | Larger than 200 |

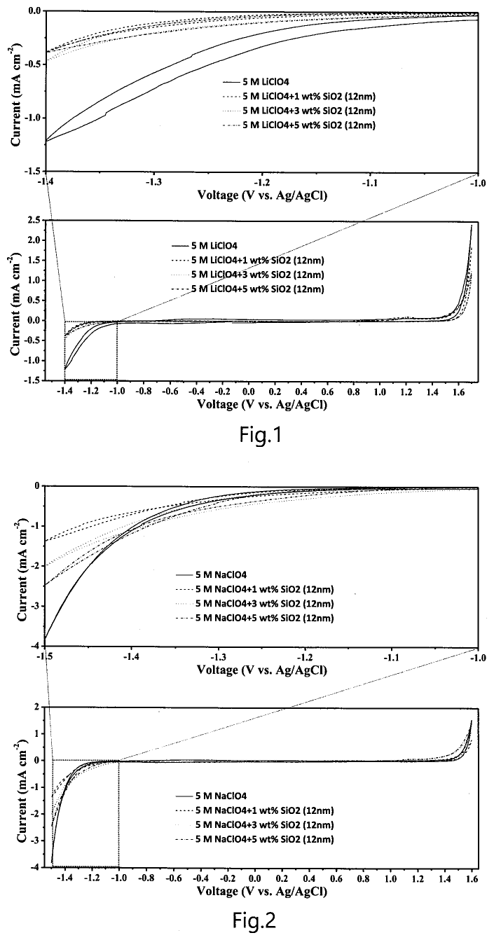

The cycle voltage-current graph of the water-based electrolytic solutions for sodium ion batteries prepared in Examples 16 to 18 is shown in FIG. 2. As is evident from FIG. 2, it was observed that the reduction potential of a negative electrode was obviously negatively shifted as a result of adding SiO₂ as an additive to the water-based electrolytic solution, as compared with the case of adding no additive. Specific numerical values are shown in Table 4 below.

TABLE 4

| | | Negative shift value of negative |
|---|---|---|
| | SiO₂ content | electrode reduction potential |
| Example 16 | 1 wt % | 90 mV |
| Example 17 | 3 wt % | 60 mV |
| Example 18 | 5 wt % | 50 mV |

### EXAMPLES 19 TO 27

Water-based electrolytic solutions for lithium ion batteries of Examples 19 to 27 were prepared in the same way as in Examples 1 to 8 except that LiTFSI was used as the lithium ion salt. These water-based electrolytic solutions were subjected to a cycle voltage-current test in the same way as in Examples 1 to 8.

The pH values and conductivities of the water-based electrolytic solutions for lithium ion batteries prepared in Examples 19 to 27 are shown in Table 5 below.

TABLE 5

| | LiTFSI salt | | | |
|---|---|---|---|---|
| | concentration | SiO₂ content | pH | Conductivity |
| | (M) | (wt %) | value | (mS/cm) |
| Example 19 | 1 | 1 | 5.15 | 28.6 |
| Example 20 | 1 | 3 | 4.94 | 27.9 |
| Example 21 | 1 | 5 | 4.80 | 26.5 |
| Example 22 | 3 | 1 | 5.59 | 40.5 |
| Example 23 | 3 | 3 | 5.54 | 39.9 |
| Example 24 | 3 | 5 | 4.71 | 38.1 |
| Example 25 | 5 | 1 | 5.85 | 42.7 |
| Example 26 | 5 | 3 | 5.77 | 40.8 |
| Example 27 | 5 | 5 | 5.44 | 38.3 |

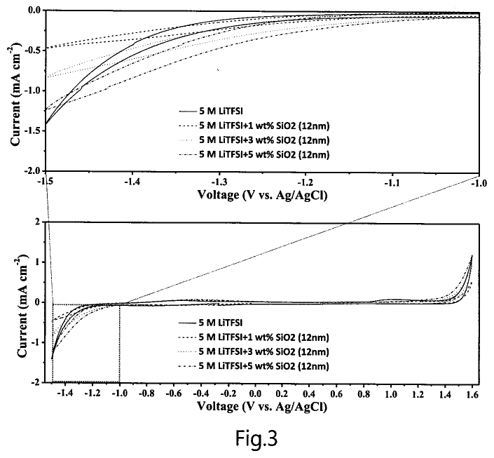

The cycle voltage-current graph of the water-based electrolytic solutions for lithium ion batteries prepared in Examples 25 to 27 is shown in FIG. 3. As is evident from FIG. 3, it was observed that the reduction potential of a negative electrode was obviously negatively shifted as a result of adding SiO₂ as an additive to the water-based electrolytic solution, as compared with the case of adding no additive. Specific numerical values are shown in Table 6 below.

TABLE 6

| | | Negative shift value of negative |
|---|---|---|
| | SiO₂ content | electrode reduction potential |
| Example 25 | 1 wt % | 120 mV |
| Example 26 | 3 wt % | 60 mV |
| Example 27 | 5 wt % | 20 mV |

### EXAMPLES 28 TO 36

Water-based electrolytic solutions for sodium ion batteries of Examples 28 to 36 were prepared in the same way as in Examples 10 to 18 except that NaTFSI was used as the sodium ion salt. These water-based electrolytic solutions were subjected to a cycle voltage-current test in the same way as in Examples 1 to 8.

The pH values and conductivities of the water-based electrolytic solutions for sodium ion batteries prepared in Examples 28 to 36 are shown in Table 7 below.

TABLE 7

| | NaTFSI salt | | | |
|---|---|---|---|---|
| | concentration | SiO₂ content | pH | Conductivity |
| | (M) | (wt %) | value | (mS/cm) |
| Example 28 | 1 | 1 | 7.37 | 34.1 |
| Example 29 | 1 | 3 | 6.95 | 31.3 |
| Example 30 | 1 | 5 | 6.74 | 29.4 |
| Example 31 | 3 | 1 | 7.63 | 47.3 |
| Example 32 | 3 | 3 | 7.26 | 43.3 |
| Example 33 | 3 | 5 | 6.99 | 42.5 |
| Example 34 | 5 | 1 | 7.89 | 51.8 |
| Example 35 | 5 | 3 | 7.45 | 50.8 |
| Example 36 | 5 | 5 | 7.46 | 47.6 |

It was observed that the reduction potential of a negative electrode was obviously negatively shifted as a result of adding SiO₂ as an additive to the water-based electrolytic solutions for lithium ion batteries prepared in Examples 34 to 36, as compared with the case of adding no additive. Specific numerical values are shown in Table 8 below.

TABLE 8

| | | Negative shift value of negative |
|---|---|---|
| | SiO₂ content | electrode reduction potential |
| Example 34 | 1 wt % | 100 mV |
| Example 35 | 3 wt % | 48 mV |
| Example 36 | 5 wt % | 17 mV |

### EXAMPLES 37 AND 38

Water-based electrolytic solutions for sodium ion batteries of Examples 37 and 38 were prepared in the same way as in Example 7 except that the additive SiO₂ was changed to particles having sizes of 30 and 40 nm, respectively. These water-based electrolytic solutions were subjected to a cycle voltage-current test in the same way as in Examples 1 to 8.

The pH values and conductivities of the water-based electrolytic solutions for lithium ion batteries prepared in Examples 37 and 38 are shown in Table 9 below.

TABLE 9

| | SiO₂ size | pH | Conductivity |
|---|---|---|---|
| Example 7 | 12 nm | 4.43 | Larger than 200 |
| Example 37 | 30 nm | 4.38 | Larger than 200 |
| Example 38 | 40 nm | 4.40 | Larger than 200 |

It was observed that the reduction potential of a negative electrode was obviously negatively shifted as a result of adding SiO₂ as an additive to the water-based electrolytic solutions for lithium ion batteries prepared in Examples 37 and 38, as compared with the case of adding no additive. Specific numerical values are shown in Table 10 below.

TABLE 10

| | | Negative shift value of negative |
|---|---|---|
| | SiO₂ size | electrode reduction potential |
| Example 7 | 12 nm | 190 mV |
| Example 37 | 30 nm | 192 mV |
| Example 38 | 40 nm | 187 mV |

### EXAMPLE 39

A water-based electrolytic solution for lithium ion batteries of Example 39 was prepared in the same way as in Example 7 except that Al₂O₃ having a size of 15 nm was used as the additive. The water-based electrolytic solution was subjected to a cycle voltage-current test in the same way as in Example 7.

It was observed that the reduction potential of a negative electrode was negatively shifted by 156 mV as a result of adding Al₂O₃ as an additive to the water-based electrolytic solution for lithium ion batteries prepared in Example 9, as compared with the case of adding no additive.

The present disclosure provides a water-based electrolytic solution for lithium/sodium ion batteries comprising a hydrophilic oxide nanoparticle uniformly dispersed in an aqueous solution of a lithium/sodium ion salt, and a lithium/sodium ion battery containing the electrolytic solution. The method according to the present disclosure can markedly improve the potential window of the water-based electrolytic solution by using an inexpensive oxide nanoparticle as an additive for the water-based electrolytic solution. Furthermore, this method is simple and easy to work and requires low cost. Therefore, the method is also very advantageous in achieving industrial production.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A water-based electrolytic solution for lithium/sodium ion batteries, comprising a hydrophilic oxide nanoparticle uniformly dispersed in an aqueous solution of a lithium/sodium ion salt.

2. The water-based electrolytic solution for lithium/sodium ion batteries according to claim 1, wherein the lithium ion salt is one or more of LiClO₄, LiTFSI, LiFSI, Li₂SO₄, and LiNO₃.

3. The water-based electrolytic solution for lithium/sodium ion batteries according to claim 1, wherein the concentration of the lithium ion salt is 1 to 5 mol/L.

4. The water-based electrolytic solution for lithium/sodium ion batteries according to claim 1, wherein the hydrophilic oxide nanoparticle is one or more of SiO₂, Al₂O₃, TiO₂, and ZrO₂.

5. The water-based electrolytic solution for lithium/sodium ion batteries according to claim 1, wherein the particle size of the hydrophilic oxide nanoparticle is 7 to 40 nm.

6. The water-based electrolytic solution for lithium/sodium ion batteries according to claim 1, wherein the content of the hydrophilic oxide nanoparticle is larger than 0 and smaller than 10 wt % and is 1 to 3 wt %.

7. The water-based electrolytic solution for lithium/sodium ion batteries according to claim 1, wherein the sodium ion salt is one or more of NaClO₄, NaTFSI, NaFSI, Na₂SO₄, and NaNO₃.

8. The water-based electrolytic solution for lithium/sodium ion batteries according to claim 1, wherein the concentration of the sodium ion salt is 1 to 5 mol/L.

9. A lithium/sodium ion battery comprising the water-based electrolytic solution for lithium/sodium ion batteries according to claim 1.
